(19) United States
(12) Patent Application Publication
(10) Pub. No.: US 2023/0002091 A1
(43) Pub. Date: Jan. 5, 2023

(54) PACKING STRAP LENGTH CUTTING APPARATUS

(71) Applicant: Yang Bey Industrial Co., Ltd., Taichung (TW)

(72) Inventor: Teng-Chi Yu, Taichung (TW)

(21) Appl. No.: 17/939,918

(22) Filed: Sep. 7, 2022

Related U.S. Application Data
(63) Continuation-in-part of application No. 16/866,563, filed on May 5, 2020.

(51) Int. Cl. B65B 13/16; B65B 13/18; B26D 1/08

(52) U.S. Cl. CPC B65B 13/16; B65B 13/185; B26D 1/085

(57) ABSTRACT

A packing strap length cutting device includes a main body and a control device. The main body has a first frame and a second frame. A strap pulling unit, a calculation unit and a sensing unit are electrically connected to the control device. The strap pulling unit is connected to a strap connecting unit. Thereby, a packing strap can be automatically pulled out a predetermined length through the strap pulling unit, and then the strap cutting unit is driven by a driving member of the strap pulling unit to cut the packing strap in the predetermined length, assisting a user in completing the cutting operation quickly.

### FIELD OF THE INVENTION

The present invention relates to a packing strap length cutting apparatus, and more particularly to a packing strap length cutting apparatus.

### BACKGROUND OF THE INVENTION

In general, a packing strap is used for packing goods to avoid the goods falling due to shaking during transportation. When the goods are to be packed, a packing strap is first packed around the circumference of the goods, and then two free ends of the packing strap are inserted through a packing buckle. The two free ends of the packing strap are driven to move relative to each other by using a packing tool to tighten the packing strap, and then the packing tool is further to tighten the packing buckle to fix the packing strap, so as to achieve the purpose of packing the goods.

However, the existing packaging strap is in the form of a packing strap. In use, it is manually pulled out a predetermined length and then cut. The operation is time-consuming, and the length of the packing strap required for packing the goods needs to be calculated in advance. There will be a problem of inconsistent length. Under long-term operation, users are easily fatigued, which will reduce the efficiency of cutting operations. Accordingly, the inventor of the present invention has devoted himself based on his many years of practical experiences to solve these problems.

### SUMMARY OF THE INVENTION

The primary object of the present invention is to provide a packing strap length cutting apparatus, which is capable of automatically pulling out and cutting a predetermined length of a packaging tape to assist the user in completing the cutting operation quickly.

In order to achieve the above object, the present invention provides a packing strap length cutting apparatus, comprising a main body, including an accommodating member, the accommodating member being connected to a base; a strap pulling unit, disposed on the base, the strap pulling unit having a motor, the motor being provided with a first roller; a driving member, disposed on the base, the driving member being connected to a shaft; a strap cutting unit, including a positioning plate and a cutting member, the positioning plate being connected to the base, the positioning plate having a first perforation and a shaft hole communicating with the first perforation, the shaft hole being provided with a support shaft, the cutting member including an upper blade and a lower blade that are spaced apart from each other, wherein the upper blade has a second perforation, a linking member is fitted onto the support shaft, and the linking member is inserted through the first perforation and the second perforation.

In the packing strap length cutting apparatus provided by the present invention, the packing strap can be automatically pulled out a predetermined length through the strap pulling unit, and then the strap cutting unit is driven by the driving member to cut the packing strap in the predetermined length, thereby assisting the user in completing the cutting operation quickly.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a partial perspective view of the preferred embodiment of the present invention;

FIG. 4 is an exploded view of the strap pressing unit of the preferred embodiment of the present invention;

FIG. 5 is a partial exploded view of the strap pulling unit and the strap cutting unit of the preferred embodiment of the present invention;

FIG. 6 is an exploded view of the floating connection unit of the preferred embodiment of the present invention;

FIG. 7 is a side view of the strap pressing unit of the preferred embodiment of the present invention, wherein the strap pressing unit is at the initial position;

FIG. 8 is a side view of the strap pressing unit of the preferred embodiment of the present invention, wherein the strap pressing unit is at the strap pressing position;

FIG. 9 is a side view of the strap pressing unit of the preferred embodiment of the present invention, wherein the strap pressing unit is at the strap cutting position;

FIG. 10 is a first schematic view of the preferred embodiment of the present invention when in use, showing that the linking member is pressed down by the strap pressing unit;

FIG. 11 is a second schematic view of the preferred embodiment of the present invention when in use, showing that the linking member is pressed down by the strap pressing unit;

FIG. 12 is a side view of the strap pressing unit of the preferred embodiment of the present invention, wherein the upper blade is pushed back by the fixing blocks;

FIG. 13 is a schematic view of the preferred embodiment of the present invention when in use, showing that the floating connection unit is swung; and

FIG. 14 is a schematic view of the preferred embodiment of the present invention when in use, showing that the sensing unit is configured to sense the packing strap, and

FIG. 15 is a partial exploded view of another embodiment of the present invention.

### DETAILED DESCRIPTION OF THE PREFERRED EMBODIMENTS

Embodiments of the present invention will now be described, by way of example only, with reference to the accompanying drawings.

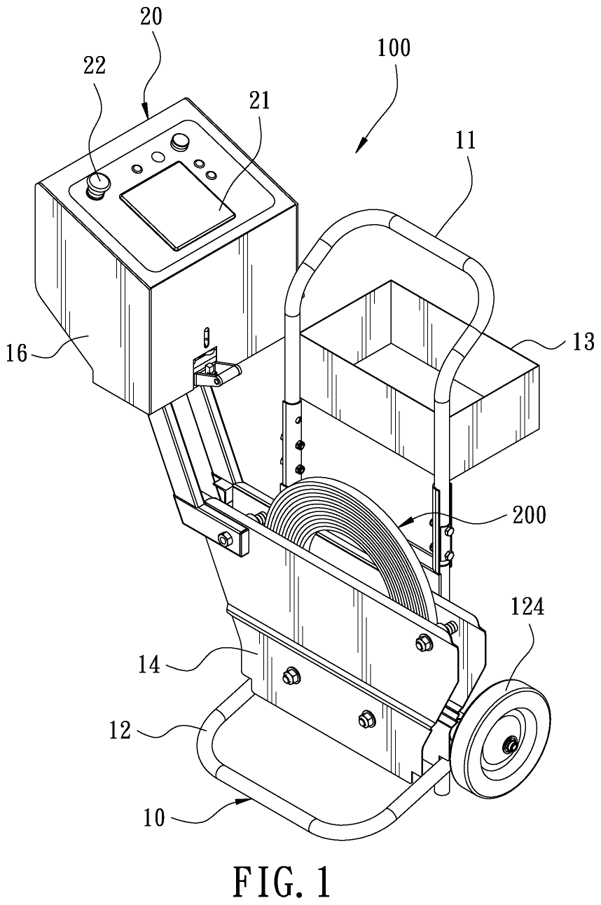

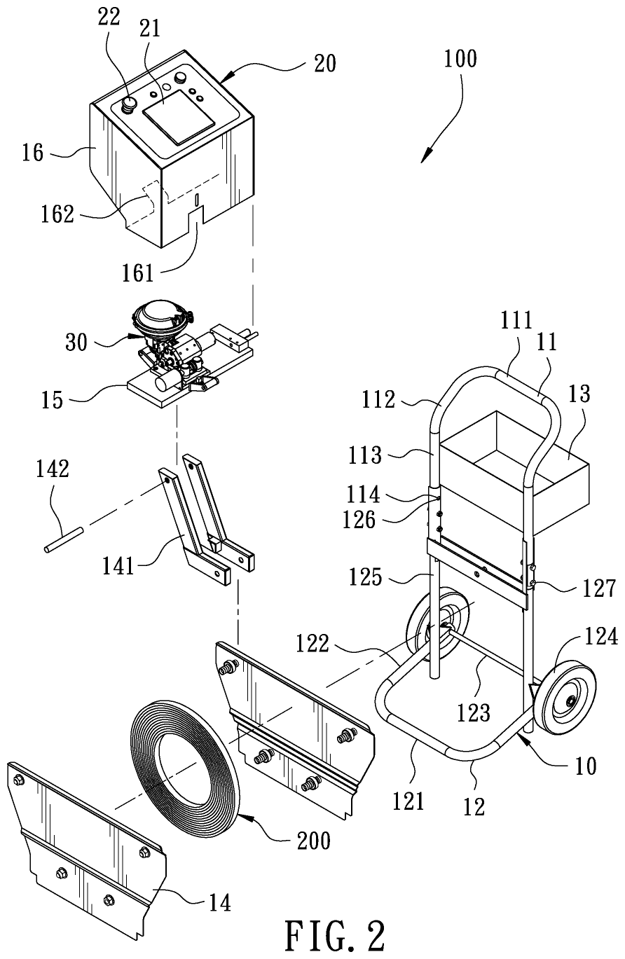

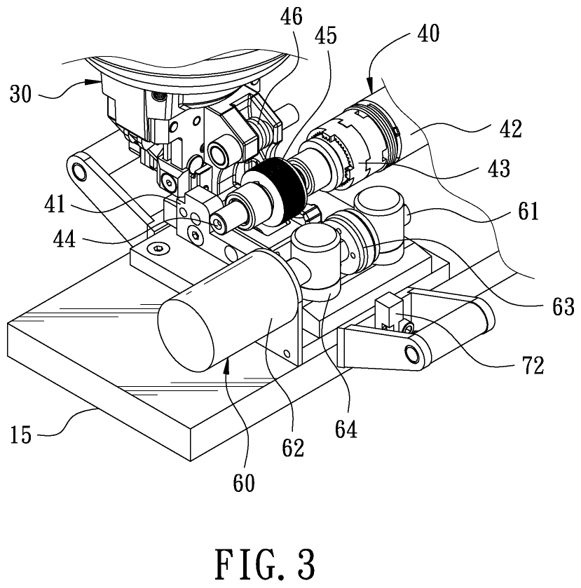

FIG. 1 is a perspective view of a preferred embodiment of the present invention. FIG. 2 is an exploded view of the preferred embodiment of the present invention. FIG. 3 is a partial perspective view of the preferred embodiment of the present invention. The present invention discloses a packing strap length cutting apparatus 100, comprising a main body 10, a control device 20, a strap pressing unit 30, a strap pulling unit 40, a strap cutting unit 50, a calculation unit 60, a sensing unit 70, and a floating connection unit 80.

The main body 10 is a metal strap dispenser, and comprises a first frame 11 and a second frame 12. The first frame 11 has a first transverse rod 111. Two ends of the first transverse rod 111 are connected to first connecting rods 112, respectively. The first connecting rods 112 are vertically connected to first coupling rods 113, respectively. The first coupling rods 113 are provided with a plurality of first positioning holes 114, respectively. A storage box 13 is provided between the first coupling rods 113 for storing tools. The second frame 12 has a second transverse rod 121. Two ends of the second transverse rod 121 are connected to second connecting rods 122, respectively. A wheel shaft 123 is insertedly connected to the second connecting rods 122. Two ends of the wheel shaft 123 are provided with wheels 124. The second connecting rods 122 are vertically connected to second coupling rods 125, respectively. The second coupling rods 125 are coupled to the first coupling rods 113, respectively. The second coupling rods 125 are provided with a plurality of second positioning holes 126 corresponding to the first positioning holes 114, respectively. The first positioning holes 114 and the second positioning holes 126 are secured by a plurality of positioning bolts 127. The positioning bolts 127 are configured to adjust the height of the first frame 11 and the second frame 12. The second frame 12 is provided with two accommodating members 14. The accommodating members 14 are disposed on one side of the second coupling rods 125. A packing strap 200, such as an iron strap, is disposed between the accommodating members 14. A pair of extension rods 141 is connected to the accommodating members 14. A fixing rod 142 is insertedly connected to the other ends of the extension rods 141. A base 15 is connected to the fixing rod 142. The base 15 is covered with an outer casing 16. A bottom of the outer casing 16 is formed with a first opening 161 and a second opening 162 close to the base 15.

The control device 20 is electrically connected to a power supply member. The control device 20 includes a panel 21 and a plurality of buttons 22 on the outer casing 16. The buttons 22 are configured to operate the packing strap length cutting apparatus 100 and set the length and unit of the packing strap 200.

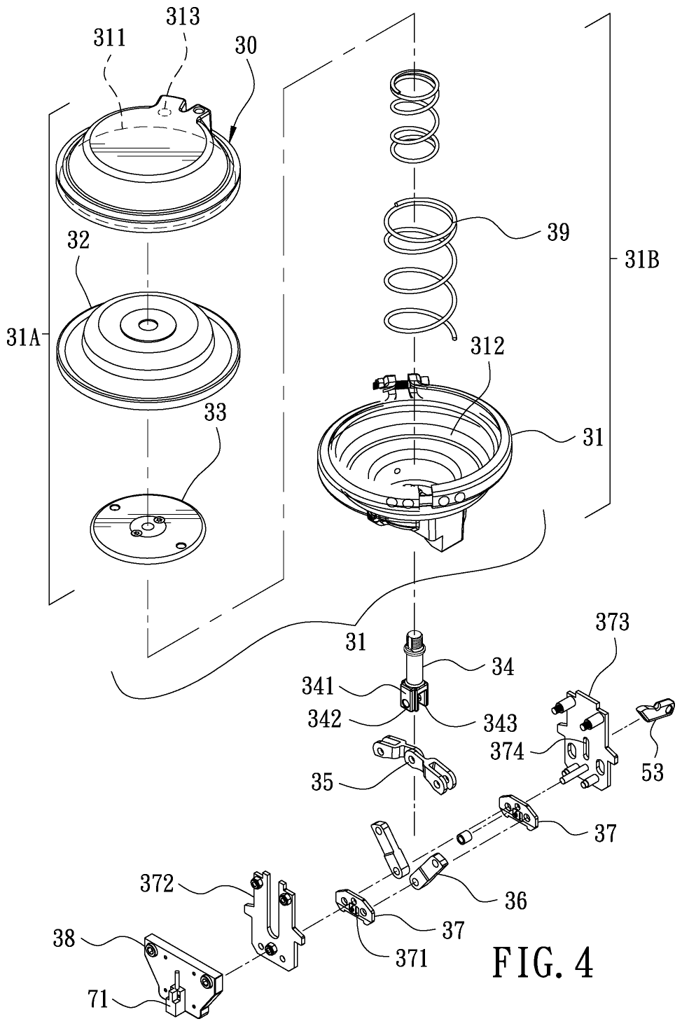

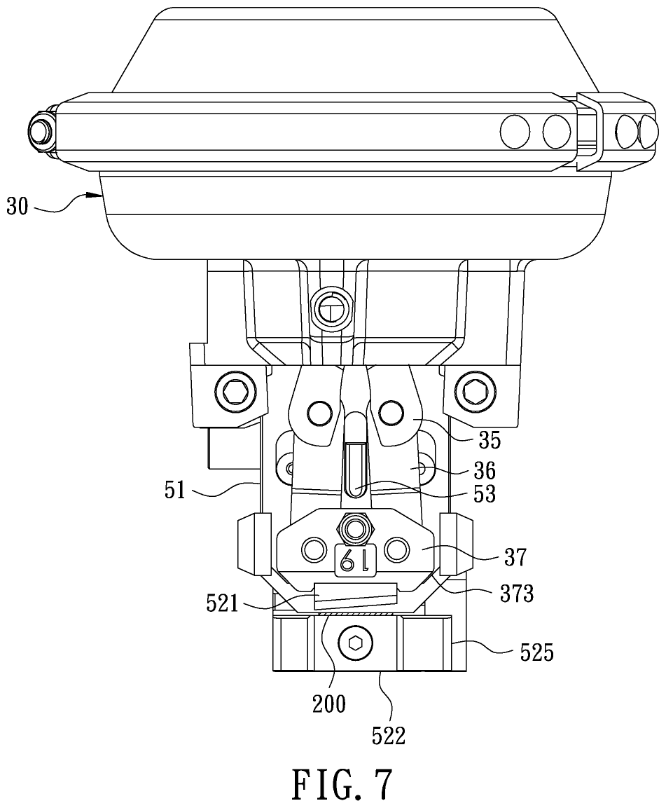

FIG. 4 and FIG. 7 are an exploded view and a side view of the strap pressing unit of the preferred embodiment of the present invention. The strap pressing unit 30 is disposed on the base 30. The strap pressing unit 30 has a driving member 31. The driving member 31 is a pneumatic cylinder. The driving member 31 has a first portion 31A and a second portion 31B joined together to form the pneumatic cylinder. A sealing pad 32 and a pressing plate 33 are provided in the first portion 31A, so that the driving member 31 is formed with a first chamber 311 and a second chamber 312. The first portion 31A has a through hole 313 communicating with the first chamber 311. The through hole 313 is provided with a control valve for controlling intake and exhaust. A shaft 34 is connected to the pressing plate 33. One end of the shaft 34, opposite to the pressing plate 33, is provided with a pivot portion 341. The pivot portion 341 has a reverse U shape, so that a front contact surface 342 and a second contact surface 343 are formed on front edges of one end of the pivot portion 341, opposite to the shaft 34. The first contact surface 342 and the second contact surface 343 are located on the same plane and spaced apart from each other. A pair of link rods 35 is pivotally connected to the pivot portion 341 through a pivot shaft. Clamping rods 36 are pivotally connected to the other ends of the link rods 35, respectively. A pair of fixing blocks 37 is pivotally connected to the other ends of the clamping rods 36. The fixing blocks 37 each have a limiting groove 371. Fixing plates 372, 373 are connected to the outer sides of the fixing blocks 37, respectively. A connecting shaft is insertedly connected to the fixing blocks 37 and the fixing plates 372, 373 for connecting the fixing blocks 37 and the fixing plates 372. The other side of the fixing plate 372 is provided with a cover plate 38 that is spaced apart from the fixing plate 372. The cover plate 38 is fixedly connected to the driving member 31. At least one spring 39 is sleeved on the shaft 34. Two ends of the spring 39 abut against the pressing plate 33 and the inner side wall of the second chamber 312, respectively.

The strap pulling unit 40 is electrically connected to the control device 20. The strap pulling unit 40 has a seat 41 and a motor 42. The seat 41 is disposed on the base 15. The seat 41 is slightly L-shaped. The seat 41 has an arc-shaped groove 411 and a shaft hole 413. One side of the seat 41 is provided with a receiving groove 412 relative to the strap pressing unit 30. A gear set 43 is connected to the motor 42. A driving shaft 44 is connected to the gear set 43. A first roller 45 is sleeved on the driving shaft 44. The driving shaft 44 and the first roller 45 are accommodated in the arc-shaped groove 411. The arc-shaped groove 411 and the first roller 45 are spaced apart from each other. At least one bracket 42 is fitted to the motor 42. One side of the bracket 42, close to the first roller 45, is provided with a fixing shaft 422 pivotally connected to the shaft hole 413 and an elastic member 46 sleeved onto the fixing shaft 422. The elastic member 46 abuts against the seat 41 and the strap pulling unit 40, so that the strap pulling unit 40 have a pre-tightness force toward the packing strap 200. In this embodiment of the present invention, the gear set 43 is a reduction gear, and the first roller 45 is a knurl wheel.

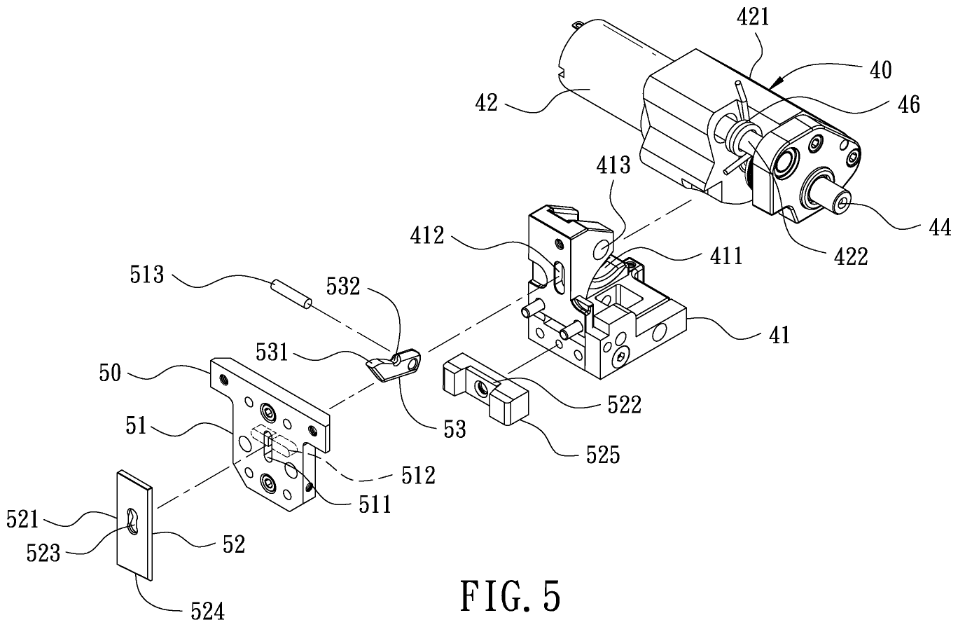

FIG. 5 is a partial exploded view of the strap pulling unit and the strap cutting unit of the preferred embodiment of the present invention. The strap cutting unit 50 includes a positioning plate 51 and a cutting member 52. The positioning plate 51 is connected to one side of the seat 41 close to the receiving groove 412 and fixed to the driving member 31, so that the positioning plate 51 is disposed between the seat 41 and the strap pressing unit 30. The positioning plate 51 has a first perforation 511 corresponding to the receiving groove 412 of the seat 41 and a shaft hole 512 communicating with the first perforation 511. The shaft hole 512 is provided with a support shaft 513. The cutting member 52 includes an upper blade 521, a lower cutting blade seat 525, and a lower blade 522. The upper blade 521 is located between the fixing plate 373 and the positioning plate 51. The upper blade 521 has a second perforation 523 corresponding to the receiving groove 412 and the first perforation 511. One end of the upper blade 521, close to the lower blade 522, has a cutting bevel 524. A linking member 53 is fitted onto the support shaft 513. The linking member 53 is inserted through the receiving groove 412, the first perforation 511, the second perforation 523, and a through groove 374 of the fixing plate 373. One side of the linking member 53 is located between the shaft 34 and the fixing block 37, and is formed with an arc-shaped protrusion 531 and an arc-shaped recess 532. The protrusion 531 is spaced apart from the recess 532, so that the protrusion 531 and the recess 532 can be pushed by the first contact surface 342 and the second contact surface 343 of the shaft 34. In this way, the linking member 53 is moved downward with the support shaft 513 as the center to press the upper blade 521 down. The lower blade seat 525 is fixed to the seat 41. The lower blade seat 525 has the lower blade 522.

The calculation unit 60 is electrically connected to the control device 20. The calculation unit 60 has a transmission shaft 61. One end of the transmission shaft 61 is provided with an encoder 62. The transmission shaft 61 is provided with a second roller 63 corresponding in position to the first roller 45. In this embodiment of the present invention, the second roller 63 is a calculating rubber wheel. Two sides of the second roller 63 are provided with limiting members 64, respectively, for limiting the moving direction of the packing strap 200.

The sensing unit 70 includes a first sensing member 71 and a second sensing member 72. The first sensing member 71 and the second sensing member 72 are electrically connected to the control device 20. In this embodiment of the present invention, the first sensing member 71 is a front sensing switch for sensing whether the packing strap 200 is jammed, and the second sensing member 72 is a rear sensing switch for sensing whether the packing strap 200 is used up. The first sensing member 71 is connected to the cover plate 38 and is close to the second opening 162, and the second sensing member 72 is disposed on the base 15 and is close to the first opening 161 and the calculation unit 60.

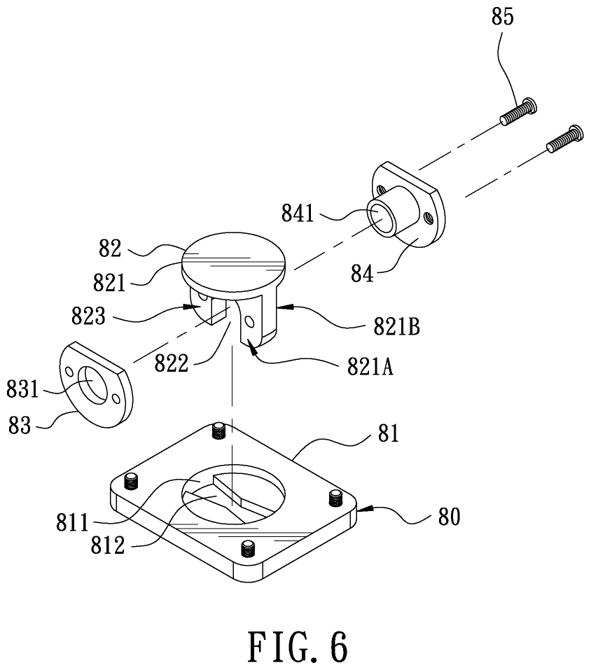

FIG. 6 is an exploded view of the floating connection unit of the preferred embodiment of the present invention. The floating connection unit 80 is connected to the fixing rod 142 and the base 15 and is located at a relative position under the strap pulling unit 40. The floating connection unit 80 has a coupling seat 81 and a swing member 82. The coupling seat 81 is fixed to the base 15. The coupling seat 81 has a circular hole 811 and an adjustment hole 812. The swing member 82 has a platy swing block 821. The swing block 821 has a pair of protrusions 823 having a first side 821A and a second side 812B. The swing member 82 is accommodated in the circular hole 811. The swing block 821 is accommodated in and extends out of the adjustment hole 812. The cross-sectional area of the swing block 821 is less than the cross-sectional area of the adjustment hole 812. In this embodiment of the present invention, the adjustment hole 812 is an X-shaped elongated hole. The width of the center of the adjustment hole 812 is less than the diameter of the adjustment hole 812. The swing block 821 has a groove 822. The groove 822 is a U-shaped groove formed between the two protrusions 823. A first plate 83 and a second plate 84 are connected to two sides of the swing block 821. A first plate 83 and the second plate 84 are slightly semicircular. The first plate 83 has a post hole 831. The second plate 84 has a protruding post 841 corresponding to the post hole 831. The protruding post 841 of the second plate 84 passes through the groove 822 and the post hole 831 of the first plate 83. The first plate 83 and the second plate 84 are fixed to the swing member 82 by a plurality of bolts 85. The fixing rod 142 is inserted through the swing member 82, the first plate 83 and the second plate 84.

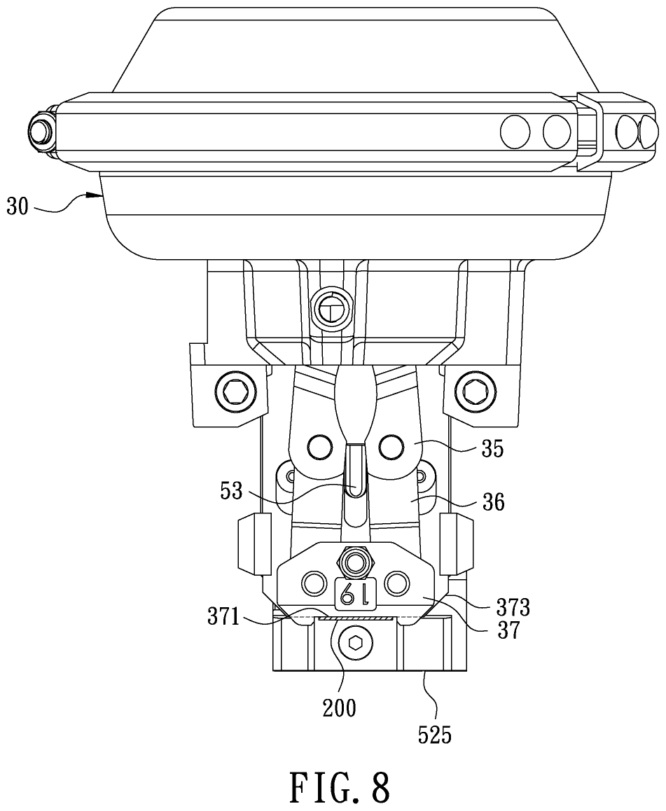

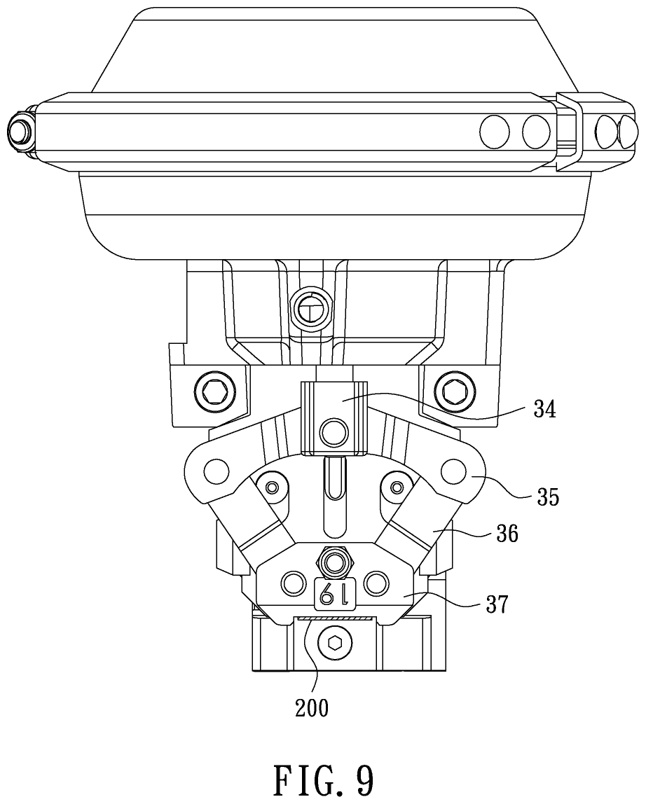

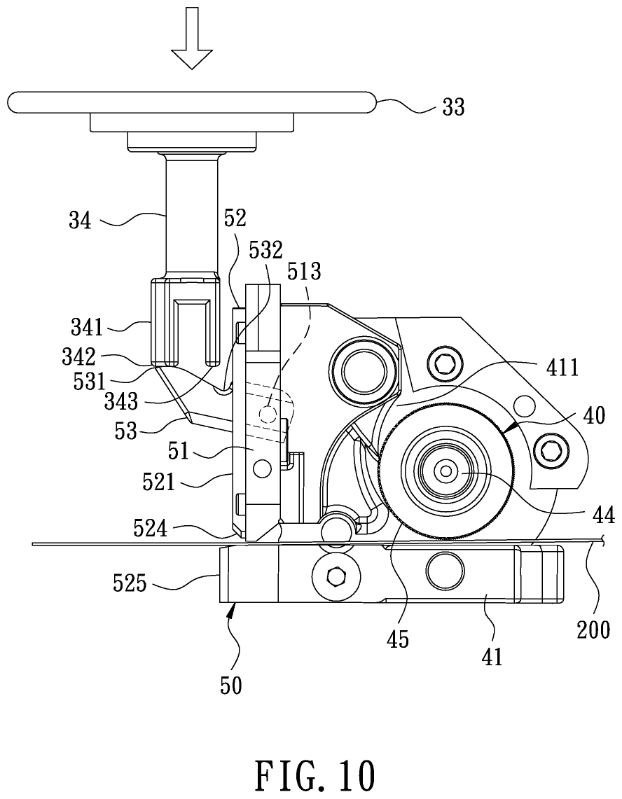

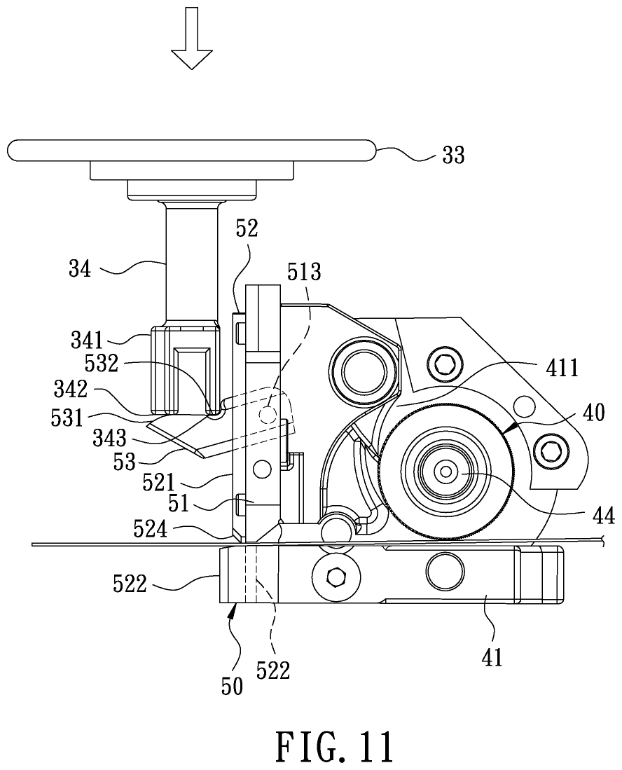

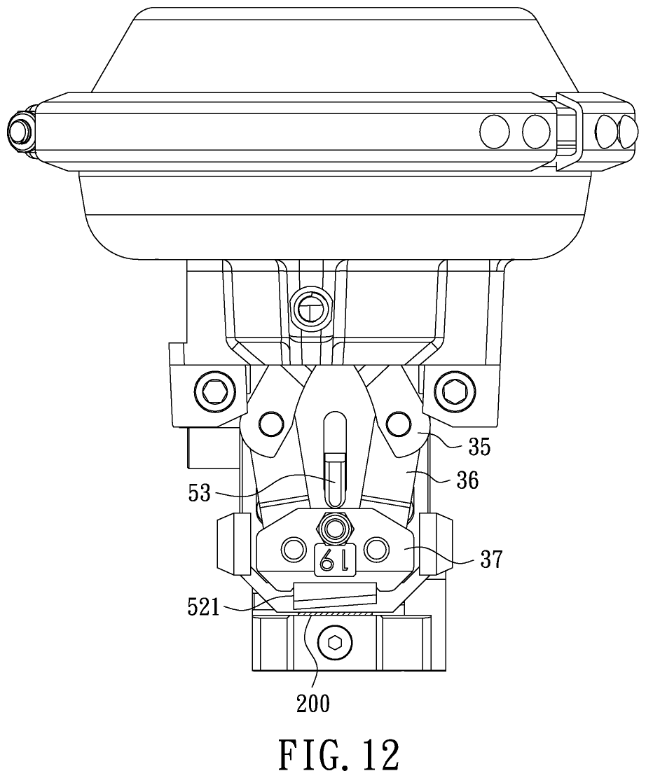

FIG. 10 is a schematic view of the preferred embodiment of the present invention when in use. When a user wants to perform a cutting operation, first, the control device 20 is activated, and the buttons 22 are used for setting the length of the packing strap 200 for the calculation unit 60. Then, the packing strap 200 is pulled to the position of the first roller 45. The first roller 45 drives the packing strap 200 to pass through the second opening 162 via the strap cutting unit 50. The second roller 63 and the encoder 62 calculate the length of the packing strap 200 to be pulled out. When the predetermined length of the packing strap 200 is reached, the control valve controls the high-pressure gas to enter the first chamber 311 through the through hole 313 to move the sealing pad 32, the pressing plate 33 and the shaft 34 toward the linking member 53 and the packing strap 200. The shaft 34, the link rods 35 and the clamping rods 36 are moved downward from the initial position shown in FIG. 7. Next, referring to FIG. 8, when the fixing plate 373 abuts against the lower blade seat 525, the packing strap 200 is positioned at the limiting groove 371 of the fixing blocks 37. Next, referring to FIG. 9, the shaft 34 is further moved downward to link the link rods 35 to press against the clamping rods 36 to rotate relative to each other. Before cutting the packing strap 200, the fixing blocks 37 continue to hold the packing strap 200. Next, referring to FIG. 10 and FIG. 11, at the same time, the pivot portion 341 of the shaft 34 abuts against the linking member 53, and the upper blade 521 is pressed downward by the linking member 53 so that the cutting bevel 524 of the upper blade 521 is against the packing strap 200. Through the cutting bevel 524, the packing strap 200 is quickly cut to complete the cutting operation. After that, the control valve controls the high-pressure gas in the first chamber 313 to be exhausted, and the spring 39 pushes the sealing pad 32 and the pressing plate 33 upward, while the shaft 34, the link rods 35, the clamping rods 36 and the fixing blocks 37 are driven to their original positions. The fixing blocks 37 push the upper blade 521 back to perform the cutting operation again, as shown in FIG. 12.

The pivot portion 341 is formed with the first contact surface 342 and the second contact surface 343, and one side of the linking member 53 is formed with the protrusion 531 and the recess 532. In this way, when the shaft 34 is moved downward, the first contact surface 342 pushes against the protrusion 531 a distance, and then the second contact surface 343 pushes against the recess 532. The protrusion 531 and the recess 532 are arc-shaped, so they can be pressed stably, thereby reducing the stagnation between the pivot portion 341 of the shaft 34 and the linking member 53, so that the pivot portion 341 of the shaft 34 is more coherent and smoother when moving relatively.

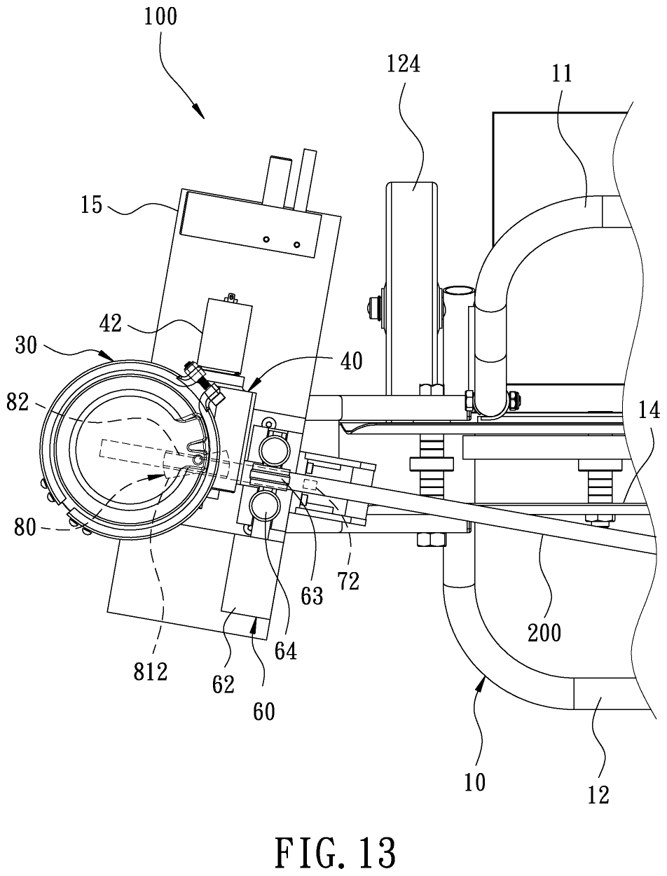

FIG. 13 is a schematic view of the preferred embodiment of the present invention when in use. Finally, the floating connection unit 80 can automatically adjust to the position of the packing strap 200 to be pulled out according to the position of the packing strap 200 to be pulled out. It is worth mentioning that the coupling seat 81 has the adjustment hole 812 and the swing member 82 is accommodated in the adjustment hole 812. Since the adjustment hole 812 is an X-shaped hole, the swing member 82 can swing in the gaps of the adjustment hole 812. The coupling seat 81 and the base 15 can be automatically adjusted according to the angle of the packing strap 200 to be pulled out, so that the packing strap 200 is located between the limiting members 64 to pass straight through the packing strap length cutting device 100, so as to reduce the situation that the packing strap is jammed and failures. The user can quickly complete the cutting operation.

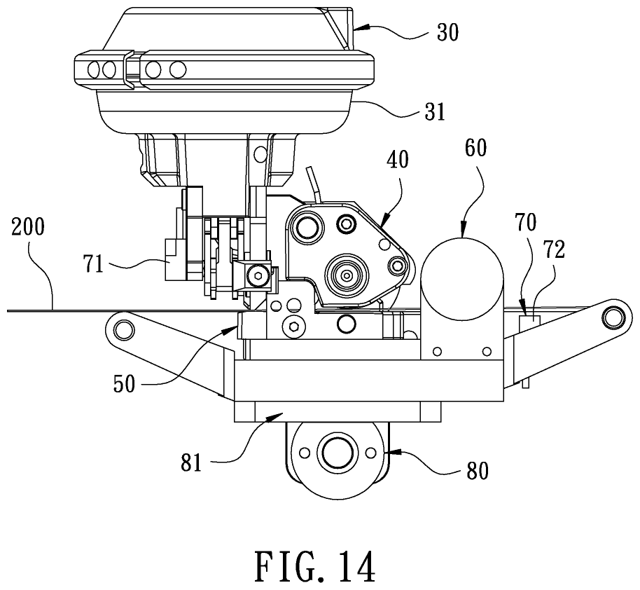

FIG. 14 is a schematic view of the preferred embodiment of the present invention when in use. It is worth mentioning that the first sensing member 71 is a front sensing switch for sensing whether the packing strap 200 is jammed, and the second sensing member 72 is a rear sensing switch for sensing whether the packing strap 200 is used up. When the first sensing member 71 or the second sensing member 72 senses that the packing strap is jammed or pull abnormally, the first sensing member 71 or the second sensing member 72 sends the signal to the control device 20 to control the motor 42 to stop. This allows the user to eliminate the abnormal situation of the packing strap in real time to increase the efficiency of use.

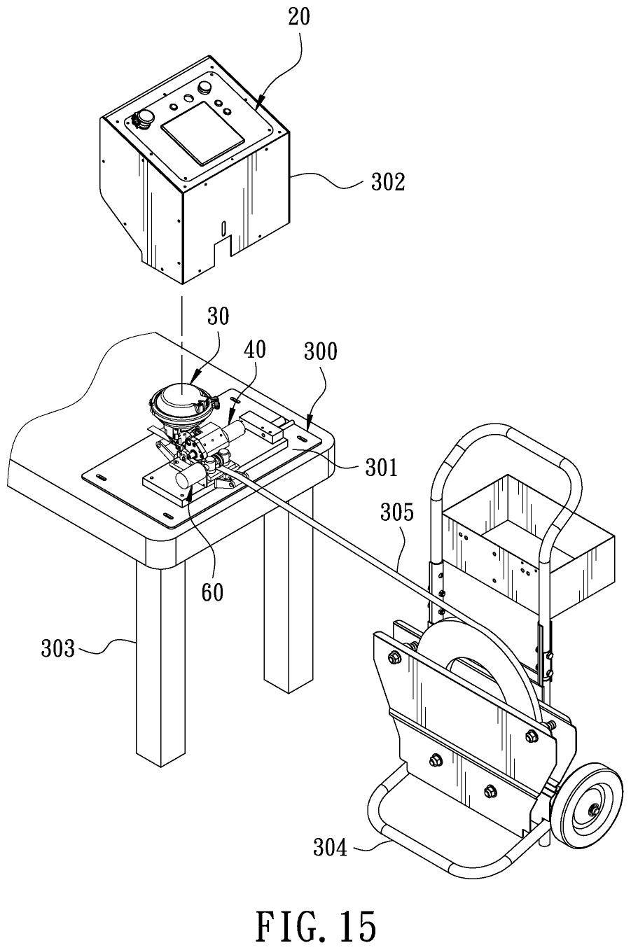

FIG. 15 illustrates a packing strap length cutting apparatus 300 according to another embodiment of the present invention. The packing strap length cutting apparatus 300 has a base 301 and an outer casing 302. The base 301 is fixed to a workbench 303. A control device 20, a strap pressing unit 30, a strap pulling unit 40, a strap cutting unit, a calculation unit 60 and a sensing unit are disposed on the base 301 and are the same as those of the foregoing preferred embodiment. The strap pulling unit 40 is configured to pull a packing strap 305 disposed on a metal strap dispenser 304. Thereby, the packing strap length cutting apparatus 300 can use the existing metal strap dispenser or directly use a roll of packing strap for strap supply. After the strap is pulled for a predetermined length, the strap is cut to complete the cutting operation quickly.

What is claimed is:

1. A packing strap length cutting apparatus, comprising:
a base;
a strap pulling unit, having a seat and a motor, the seat being disposed on the base, the motor being provided with a bracket and a first roller, the bracket having a fixing shaft, the fixing shaft being disposed on the base;
a driving member, disposed on the base and connected to the seat, a sealing pad and a pressing plate being provided in the driving member, the pressing plate being connected to a shaft;
a strap cutting unit, including a positioning plate and a cutting member, the positioning plate being connected to the seat, the positioning plate having a first perforation and a shaft hole communicating with the first perforation, the shaft hole being provided with a support shaft, the support shaft being connected to one end of a linking member, the cutting member including an upper blade and a lower blade seat, wherein the upper blade is located on one side of the positioning plate, the upper blade has a second perforation, another end of the linking member passes through the first perforation and the second perforation and is located below the shaft, the lower blade seat is disposed on the seat, and the lower blade seat has a lower blade;
wherein the first roller of the strap pulling unit receives a packing strap and enables the packing strap to move toward the strap cutting unit, the shaft pushes the linking member downward and further pushes the upper blade to cut the packing strap.

2. The packing strap length cutting apparatus as claimed in claim 1, wherein one end of the shaft has a first contact surface and a second contact surface, the first contact surface and the second contact surface are spaced apart from each other, one side of the linking member is formed with an arc-shaped protrusion and an arc-shaped recess, the protrusion and the recess are spaced substantially apart from each other and operably engage with the first contact surface and the second contact surface, respectively.

3. The packing strap length cutting apparatus as claimed in claim 1, wherein one end of the shaft, opposite to the pressing plate, is provided with a pivot portion, a pair of link rods is pivotally connected to the pivot portion, clamping rods are pivotally connected to another ends of the link rods respectively, a pair of fixing blocks is pivotally connected to another ends of the clamping rods, and one side of the linking member is located between the shaft and the pair of fixing blocks.

4. The packing strap length cutting apparatus as claimed in claim 1, wherein the packing strap length cutting apparatus further comprises a strap dispenser and a floating connection unit, the strap dispenser has an accommodating member, at least one extension rod is connected to the accommodating member, a fixing rod is insertedly connected to the extension rod, the floating connection unit has a coupling seat and a swing member, the coupling seat is fixed to the base, the coupling seat has an adjustment hole, the swing member is connected to the fixing rod, the swing member has a swing block, and the swing block is swingable in the adjustment hole.

5. The packing strap length cutting apparatus as claimed in claim 4, wherein the coupling seat has a circular hole, the swing member is accommodated in the circular hole, and the adjustment hole is an elongated hole.

6. The packing strap length cutting apparatus as claimed in claim 4, wherein the swing block has a groove and a pair of protrusions, the groove is formed between the pair of protrusions, a first plate and a second plate are connected to the swing block, the first plate has a post hole, the second plate has a protruding post corresponding to the post hole, the protruding post of the second plate is inserted through the groove and the post hole of the first plate, and the fixing rod is inserted through the swing member, the first plate and the second plate.

7. The packing strap length cutting apparatus as claimed in claim 1, wherein the seat has an arc-shaped groove, the positioning plate is disposed between the seat and the driving member, and one end of the upper blade, close to the lower blade, has a cutting bevel.

8. The packing strap length cutting apparatus as claimed in claim 4, wherein the strap dispenser includes a first frame and a second frame, the first frame has a plurality of first positioning holes, a wheel shaft is insertedly connected to the second frame, two ends of the wheel shaft are provided with wheels, the second frame has a plurality of second positioning holes corresponding to the first positioning holes, the first positioning holes and the second positioning holes are secured by a plurality of positioning bolts, and one side of the second frame is provided with the accommodating member.
